(19) United States
(12) Patent Application Publication
(10) Pub. No.: US 2011/0029771 A1
(43) Pub. Date: Feb. 3, 2011

(54) Enrollment Agent for Automated Certificate Enrollment

(75) Inventors: Manish Mehta, Santa Clara, CA (US); Shekhar Kshirsagar, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ARUBA NETWORKS, INC., Sunnyvale, CA (US)

(21) Appl. No.: 12/510,725

(22) Filed: Jul. 28, 2009

(51) Int. Cl. H04L 9/00

(52) U.S. Cl. 713/156

(57) ABSTRACT

Automated generation of certificates from a Certificate Authority through the use of an Enrollment Agent. Devices needing certificates generate the necessary keys and package public key information with other identifying information about the device and send this information to an Enrollment Agent. The Enrollment Agent takes this information and submits it on behalf of the device to a Certificate Authority, managing the interaction with the Certificate Authority on behalf of the device. The Certificate Authority signs the request, returning a certificate to the Enrollment Agent. The Enrollment Agent packages the certificate along with the other certificates needed to establish a chain of trust and returns these to the device. Certificates may be stored in the device in flash memory. The process is secure as long as the communications path between the devices and the Enrollment Agent is secure; a secure VPN or HTTPS: connection allows the devices and the Enrollment Agent to be in separate locations.

### BACKGROUND OF THE INVENTION

The present invention relates to the generation of certificates, and more particularly, to the process of enrolling devices with a Certificate Authority (CA) to obtain certificates for the devices in a manufacturing setting.

The process of enrolling a device with a Certificate Authority (CA) involves interacting with the CA, sending it a certificate request based in part on a public key. The CA cryptographically signs the request, producing a certificate. This certificate, along with the certificate for the CA itself, and other such certificates needed to establish identity are stored in the requesting device, a process known as provisioning, thus providing a chain of certificates which may be verified during later device operation.

What is needed is a way of enrolling devices and obtaining certificates for them in a manufacturing environment.

### BRIEF DESCRIPTION OF THE DRAWINGS

The invention may be best understood by referring to the following description and accompanying drawings that are used to illustrate embodiments of the invention in which:

FIG. 1 shows a network with an Enrollment Agent.

### DETAILED DESCRIPTION

Embodiments of the invention relate to methods of enrolling devices with a Certificate Authority to obtain certificates through an Enrollment Agent.

An Enrollment Agent (EA) interacts with a Certificate Authority (CA) on behalf of a device to be registered with the CA. A helper program runs on the device to be enrolled, and communicates with the Enrollment Agent. The Enrollment Agent receives information from the device to be enrolled, and manages the conversation with the Certificate Authority on behalf of the device to obtain certificates signed by the CA for the device. The device certificate and additional certificates needed to verify the chain of trust are sent to the device. The device to be enrolled may be physically separate from the EA and CA if a secure communications path between the device and the EA/CA is provided.

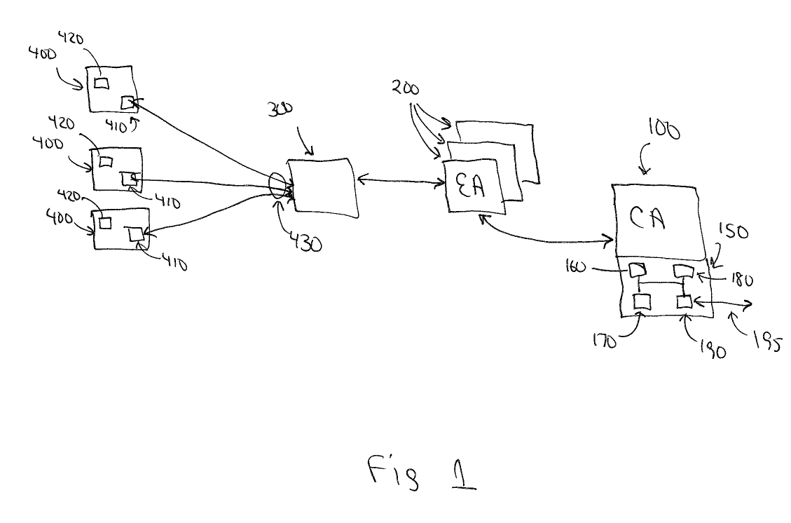

FIG. 1. shows a network environment in which Certificate Authority 100 is a computer process. This process is in communication with Enrollment Agent 200, also a computer process. Web server 300 is also a computer process which starts and communicates with Enrollment Agent 200 in response to requests from agent 410 running in requesting device 400.

As shown, Certificate Authority 100 is a process running on computer system 150 shown in block form. As understood in the art, a suitable computer system for hosting CA 100 has a processor 160, memory hierarchy 170, input/output interfaces 180, and network interface 190 which connects to network 195. CPU 160 may be a MIPS-class processor from companies such as Raza Microelectronics or Cavium Networks, although CPUs from companies such as Intel, AMD, IBM, Freescale, or the like may also be used. Memory hierarchy 170 includes read-only memory for device startup and initialization, high-speed read-write memory such as DRAM for containing programs and data during operation, and bulk memory such as hard disk or compact flash for permanent file storage of programs and data. Network interfaces 190 are typically IEEE 802.3 Ethernet interfaces to copper, although high-speed optical fiber interfaces may also be used.

Computer system 150 operates under control of an operating system. For the purposes of the invention, the operating system and hardware platform 150 provide the resources to support CA 100. The choice of operating system will depend largely on the CPU used, with Linux or Unix and their derivatives in common use with MIPS-class as well as Intel or AMD CPUs, while Windows may also be used with Intel and AMD CPUs.

Web server 300 and Enrollment Agent 200 are also software processes, packages of computer instructions and data. While shown separate from CA 100, it may be useful to host these processes on the same hardware platform 150 as is used to host CA 100. It should also be understood that requests may be processed directly by Enrollment Agent 200, without intermediary web server 300.

Devices 400 requiring certificates are digital devices, each having a CPU, memory hierarchy, and set of input/output interfaces as understood in the art. Devices 400 have onboard permanent storage 420 which may be in the nature of flash memory, or may be a Trusted Platform Module (TPM).

A Trusted Platform Module (TPM) is a special purpose digital microprocessor-based module which offers facilities for the secure generation of cryptographic keys in the nonvolatile memory of the TPM, and other capabilities such as remote attestation and sealed storage. These facilities may be used, for example, to authenticate computing systems. TPMs are produced by companies such as Atmel, Broadcom, Infineon, AMT, and ST Microelectronics, among others.

According to an aspect of the invention, certificates are needed for devices 400. The steps to obtain certificates from CA 100 are:

An agent 410 executing in device 400 generates one or more key pairs each containing a public key and a private key. A TPM may be used for key generation and storage if present.

Agent 410 in device 400 packages the public key with other identifying information about the device. This information may include, for example, device MAC addresses, device model number and/or type, serial number, and so on. This information is used to form the certificate.

The packaged information is sent to Enrollment Agent 200 via network 430.

In one embodiment of the invention, the packaged information is sent using standard HTTP protocols. In one embodiment, the packaged information is received directly by Enrollment Agent 200. In another embodiment, the HTTP message sent by agent 410 in device 400 is received by web server 300.

Web server 300 passes the HTTP message containing the packaged information to EA 200.

In one embodiment of the invention, web server 300 starts an Enrollment Agent process 200 for each message it receives from a device 400 and its agent 410.

EA 200 extracts contents of the message, retrieving the public key and forming a certificate request based on the public key.

EA 200 submits the certificate request to Certificate Authority 100.

CA 100 signs the request, producing a certificate.

CA 100 returns the certificate to EA 200.

EA 200 combines the signed certificate with the other certificates in the chain (CA 100 certificate, etc), packages them, and returns them to agent 410 in device 400.

Agent 410 in device 400 stores the certificates in flash memory 420

In one embodiment of the invention, CA 100 is Microsoft Certificate Authority, running on Windows Server 2008, and web server 300 is Microsoft IIS. Other Certificate Authority programs may be used, as well as other web servers, such as Apache.

According to an aspect of the invention, the security of the process is maintained of the communications path 430 between devices 400 and web server 300 and EA 200 is secure. Such security may be provided, for example, by housing devices 400 as well as web server 300, EA 200 and CA 100 in the same secure environment. Alternatively, a secure communications path 430 between devices 400 and web server 300 may be provided. For example, secure HTTPS: channels may be used for communications path 430. Or, a secure Virtual Private Network (VPN) connection 430 may be used between web server 300 and devices 400. Such secure communications paths 430 allow devices 400 to be in one secure location, such as a manufacturing plant in China, while CA 100, EA 200 and web server 300 are located in a separate secure environment in the United States.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of obtaining a certificate for a digital device through use of an Enrollment Agent, the method comprising the steps of:
forming a certificate request in the digital device, the certificate request containing at least a public key and identifying information on the digital device,
sending the certificate request from the digital device to the Enrollment Agent over a communications channel,
the Enrollment Agent, receiving the certificate request sent over the communications channel
the Enrollment Agent using the information in the request to form a certificate request,
the Enrollment Agent sending the certificate request to a Certificate Authority,
the Enrollment Agent receiving the signed certificate from the Certificate Authority, and
the Enrollment Agent returning the signed certificate to the digital device.

2. The method of claim 1 where the identification information on the digital device contains one or more of: device MAC addresses, device type, device model number, device serial number.

3. The method of claim 1 where the communications channel is a virtual private network.

4. The method of claim 1 where the communications channel is a secure HTTPS channel.

5. The method of claim 1 where the digital device includes a Trusted Platform Module which is used to form the public key.

6. The method of claim 1 where multiple public keys are contained in the request formed in the digital device.

7. The method of claim 1 where the signed certificate returned by the Enrollment Agent to the digital device includes a certificate for the Certificate Authority.

8. The method of claim 1 where the step of the Enrollment Agent receiving the certificate request further comprises:
a web server receiving the request from the digital device sent over the communications server,
the web server passing the request from the digital device to the Enrollment Agent.

9. The method of claim 8 where the web server starts an Enrollment Agent process for each message it receives from a digital device.

10. The method of claim 1, wherein said steps of claim 1 are performed by at least one machine in accordance with at least one computer program stored in a computer readable media, said computer program having a plurality of code sections that are executable by the at least one machine.

11. Software for obtaining a certificate for a digital device through use of an Enrollment Agent, the method comprising:
a helper running on the digital device configured to form a certificate request in the digital device, the certificate request containing at least a public key and identifying information on the digital device and send the certificate request from the digital device to the Enrollment Agent over a communications channel,
an Enrollment Agent, configured to receive the certificate request sent over the communications channel, and interact with a Certificate Authority to obtain a signed certificate from the Certificate authority and send the signed certificate to the digital device,
wherein the helper and Enrollment Agent are specified by digitally encoded data stored in a computer readable media, the computer readable media executable by one or more computing devices, which cause the one or more computing devices to perform a set of actions for which the helper and Enrollment Agent are configured.
